(19) United States
(12) Patent Application Publication
(10) Pub. No.: US 2026/0166638 A1
(43) Pub. Date: Jun. 18, 2026

(54) Method, Device, Electronic Equipment, and Storage Medium for Generating Stencil Openings

(71) Applicant: Vayo (Shanghai) Technology Co., Ltd., Shanghai (CN)

(72) Inventors: Jiuxuan LIU, Shanghai (CN); Pan SU, Shanghai (CN); Fengshou LIU, Shanghai (CN)

(73) Assignee: Vayo (Shanghai) Technology Co., Ltd., Shanghai (CN)

(21) Appl. No.: 19/107,051

(22) PCT Filed: Sep. 26, 2023
(86) PCT No.: PCT/CN2023/121296

§ 371 Date: Mar. 3, 2026

(30) Foreign Application Priority Data
Dec. 19, 2022 (CN) 2022116333201

(51) Int. Cl. B23K 3/06; B23K 3/08

(52) U.S. Cl. CPC B23K 3/0638; B23K 3/08

(57) ABSTRACT

A method for generating stencil openings, including: extracting pieces of pad pattern data from a solder-paste printing layer of a PCB and encoding graphical features of the pad pattern data; searching for candidate component packages in a stencil opening library based on pad pattern codes; matching pad pattern data of the candidate component packages with the pad pattern data of the PCB; generating a stencil opening layer of the PCB based on stencil opening data of the successfully matched candidate component packages, to process a stencil template according to the stencil opening layer. The present disclosure allows for the automatic identification of component packages based solely on pad pattern data without manual recognition. Subsequently, corresponding stencil opening patterns are found in the stencil opening library based on the component packages, achieving automated design of stencil openings and solving the problem of inefficiency in the stencil template manufacturing process.

### FIELD OF TECHNOLOGY

The present disclosure belongs to the field of Printed Circuit Board Assembly (PCBA) manufacturing and specifically relates to a method for generating stencil openings, a device, an electronic equipment, and a storage medium.

### BACKGROUND

In PCBA manufacturing, stencil templates are commonly used to assist solder paste printing machines in transferring solder paste onto the pads of a PCB, thereby accurately controlling the amount of solder paste transferred to the pads. A stencil template is a special mold for surface mounting, and creating a stencil template requires the use of a Gerber file. The solder-paste printing layer in the Gerber file records the pad pattern data of the components included in the PCB, and the components on the PCB usually include multiple pads.

However, the pad pattern data in the solder-paste printing layer only contain the pattern characteristics of the pads, without information on the reference designators, pins, or packaging attributes of the components. Therefore, when creating stencil templates, manual identification of the correspondence between the pad pattern data in the solder-paste printing layer and the component packages is required, followed by the reference to the stencil opening data of the component packages to create the stencil template, which results in low processing efficiency.

### SUMMARY

In order to solve the above-mentioned problems in the related art, the present disclosure provides a method for generating stencil openings, a device, an electronic equipment, and a storage medium.

The technical problems to be solved by the present disclosure are achieved through the following technical solutions.

In the first aspect, the present disclosure provides a method for generating stencil openings applied to an electronic equipment. The method comprises:
obtaining a Gerber file of PCB and extracting each pad pattern data of the PCB from a solder-paste printing layer of the Gerber file;
encoding graphical features of each pad pattern data to obtain pad pattern code;
searching for candidate component packages containing the same pad pattern code in a preset stencil opening library based on the pad pattern code of PCB pad pattern data; the stencil opening library stores component package information by component package; the component package information comprises: component package name, component package pattern, pad pattern data of the component package, and corresponding stencil opening data of the component package; each pad pattern data of the component package corresponds to a pad pattern code;
matching the pad pattern data of the searched candidate component packages with the pad pattern data of the PCB based on the pad pattern code; and
generating stencil opening layer of the PCB based on the stencil opening data of the successfully matched candidate component package, to process the stencil template according to the stencil opening layer.

In the second aspect, the present disclosure provides a device for generating stencil openings applied to an electronic equipment. The device comprises:
acquisition module, used to obtain the Gerber file of the PCB and extract the pad pattern data from the solder-paste printing layer of the Gerber file;
encoding module, used to encode the graphical features of each pad pattern data to obtain the pad pattern code;
search module, used to search for candidate component packages containing the same pad pattern code in the preset stencil opening library based on the pad pattern code of the PCB pad pattern data; the stencil opening library stores component package information by component package; the component package information comprises: component package name, component package pattern, pad pattern data of the component package, and corresponding stencil opening data of the component package; each pad pattern data of the component package corresponds to a pad pattern code;
matching-processing module, used to match the pad pattern data of the searched candidate component packages with the pad pattern data of the PCB based on the pad pattern code; and
generation module, used to generate the PCB stencil opening layer based on the stencil opening data of the successfully matched candidate component package, to process the stencil template according to the stencil opening layer.

In the third aspect, the present disclosure provides an electronic equipment, comprising a processor, a communication interface, a memory, and a communication bus, the processor, the communication interface, and the memory communicate with each other via the communication bus;
the memory is used to store computer programs;
the processor, when executing the computer program stored in the memory, to implement steps of any of aforementioned methods for generating stencil openings.

In the fourth aspect, the present disclosure provides a storage medium; the storage medium stores a computer program, which, when executed by a processor, implements steps of any of aforementioned methods for generating stencil openings.

In the method for generating stencil openings provided by the present disclosure, a stencil opening library is pre-constructed. The stencil opening library stores component package information categorized by component packages. The component package information comprises: component package name, component package pattern, pad pattern data of the component package, and stencil opening data of the component packages; each of pieces of pad pattern data of the component packages corresponds to a pad pattern code. Based on this stencil opening library, after obtaining the Gerber file of the PCB, the pad pattern data of the PCB is subjected to graphical feature encoding. The obtained pad pattern codes are then used to search the stencil opening library for candidate component packages containing the same pad pattern codes. Subsequently, the pad pattern data of the candidate component packages are matched with the pad pattern data of the PCB based on the pad pattern codes. In this way, the stencil opening layer of the PCB can be generated using the stencil opening data corresponding to the successfully matched candidate component packages. This enables the identification of component packages based solely on pad pattern data, without the need for manual recognition of component packages in the solder-paste printing layer, thereby improving processing efficiency.

The present disclosure will be further described in detail below in conjunction with the accompanying drawings.

### BRIEF DESCRIPTION OF THE DRAWINGS

FIG. 1 is a flowchart of a method for generating stencil openings provided by an embodiment of the present disclosure.

FIG. 2 illustrates two examples of component packages used to explain how to identify candidate component packages in an embodiment of the present disclosure.

FIG. 3 illustrates two examples of component packages used to explain pad angles in an embodiment of the present disclosure.

FIG. 4 exemplifies the data content of summarized pad pattern data in an embodiment of the present disclosure.

FIG. 5 illustrates two pad patterns used to explain the zeroing method in an embodiment of the present disclosure.

FIG. 6 illustrates the effect of summarizing pad pattern data in an embodiment of the present disclosure.

FIG. 7 illustrates four pad patterns used to explain the angle matching conditions in an embodiment of the present disclosure.

FIG. 8 is a flowchart illustrating the process of searching a group of matched pad pattern data for a candidate component package in an embodiment of the present disclosure.

FIG. 9 is a schematic diagram illustrating the effect of sorting and matching candidate component packages in an embodiment of the present disclosure.

FIG. 10 is a flowchart of another method for generating stencil openings implemented based on the method shown in FIG. 1.

FIG. 11 to FIG. 25 show the step-by-step operation effects during the automated generation of stencil opening layers for a solder-paste printing layer of a PCB using the method for generating stencil openings provided by an embodiment of the present disclosure.

FIG. 26 is a schematic structural diagram of an electronic equipment provided in an embodiment of the present disclosure.

### DETAILED DESCRIPTION

The present disclosure is further described below in conjunction with specific embodiments.

A method for generating stencil openings is provided by embodiments of the present disclosure. The method is primarily applied to an electronic equipment; in practical applications, the electronic equipment may be a desktop computer, a portable computer, a terminal device, or a server, among others. By executing the method for generating stencil openings provided by the embodiments of the present disclosure on the electronic equipment, the Gerber file of a PCB can be automatically analyzed to recognize component packages, automatically match the corresponding stencil opening patterns, and achieve an automated stencil opening design, resolving the inefficiency issues encountered during the stencil template creation process.

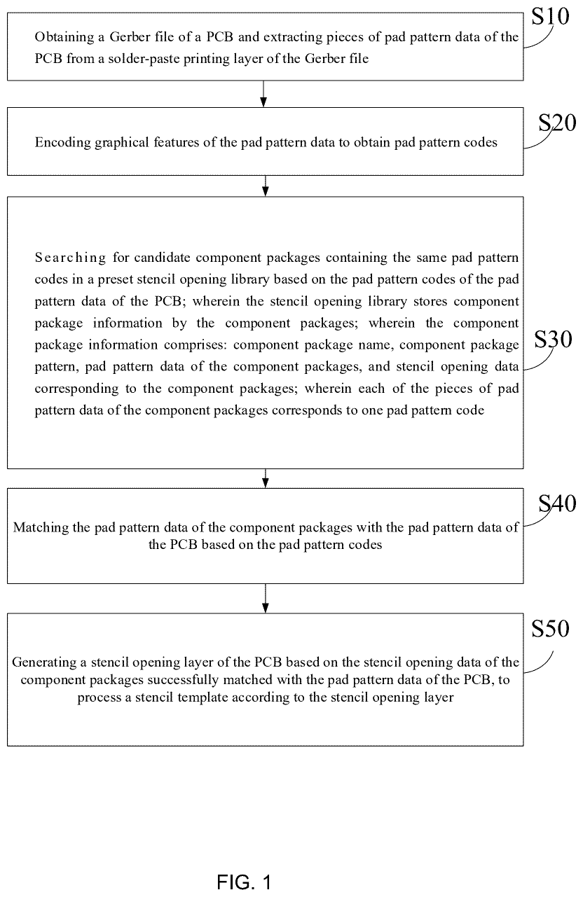

Referring to FIG. 1, the method for generating stencil openings provided by the embodiments of the present disclosure comprises the following steps.
S10: obtaining a Gerber file of a PCB and extracting pieces of pad pattern data of the PCB from a solder-paste printing layer of the Gerber file.

The Gerber file, also known as Gerber data, is a universal data format widely used in the PCB/PCBA industry for PCB manufacturing, with encoding formats that comprise RS-274D and RS-274X. The Gerber data consists of multiple files, with each file containing a single data layer. Among these, the solder-paste printing layer (also known as the PASTE layer) describes the pad patterns of all surface-mounted components requiring soldering on the PCB. The pad patterns in the layer are typically a one-to-one representation of the actual pad sizes on the PCB.

In the PCB/PCBA industry, the solder-paste printing layer is widely used for creating stencil templates. However, this layer only contains vector pattern data of the pad patterns on the PCB, without any packaging attribute information, such as the reference designators or pin details of the components. Therefore, it is impossible to determine how many or what types of component packages are included based solely on the solder-paste printing layer. Typically, a solder-paste printing layer contains hundreds, thousands, or even tens of thousands of pad patterns. By attempting to group pad patterns at different positions, various component packages can be formed. However, among these groupings, only one grouping represents the correct component package.
S20: encoding graphical features of each one of pieces of pad pattern data to obtain a pad pattern code;
Specifically, the pad pattern corresponding to the pad pattern data has its graphical features, such as the shape, length, width, area, perimeter, centroid coordinates, and symmetry marker of the pad pattern. The symmetry marker is used to indicate whether the pad pattern is symmetrical and, if so, what type of symmetrical pattern it is. It is understandable that these graphical features can be easily extracted from the vector graphic data of the pad pattern. Subsequently, several features that can effectively distinguish between different pad patterns can be selected from all the graphical features of the pad pattern. Based on the selected graphical features, encoding is performed to obtain the pad pattern code for the pad pattern data.

As an example, the pad pattern code can comprise the following information of the pad pattern corresponding to the pad pattern data: shape, length, width, area, perimeter, centroid coordinates, and symmetry mark. Accordingly, the pad pattern code can take the following format: <shape>-<length>-<width>-<area>-<perimeter>><centroid>-<symmetry mark>; the delimiter used here is not limited to the hyphen (“-”) shown in this example.
S30: searching for candidate component packages containing the same pad pattern code in a preset stencil opening library based on the pad pattern codes of PCB pad pattern data (i.e., the pad pattern data of the PCB). The stencil opening library stores component package information by component packages; the component package information comprises: component package name, component package pattern, pieces of pad pattern data of the component packages, and stencil opening data corresponding to the component packages; each one of pieces of pad pattern data of the component packages corresponds to a pad pattern code.

It is understood that the pieces of pad pattern data of component packages stored in the stencil opening library are all associated with pad pattern codes, and the encoding method is the same as that described in step S20. Accordingly, the candidate component packages containing the same pad pattern codes can be searched for in the stencil opening library based on the pad pattern codes of the PCB pad pattern data.

Specifically, the pad pattern codes obtained in step S20 are compared with the pad pattern codes recorded in the stencil opening library. If a component package has all its pad pattern codes matching the pad pattern codes of the pad pattern data from the PCB, then the component package is considered a candidate component package.

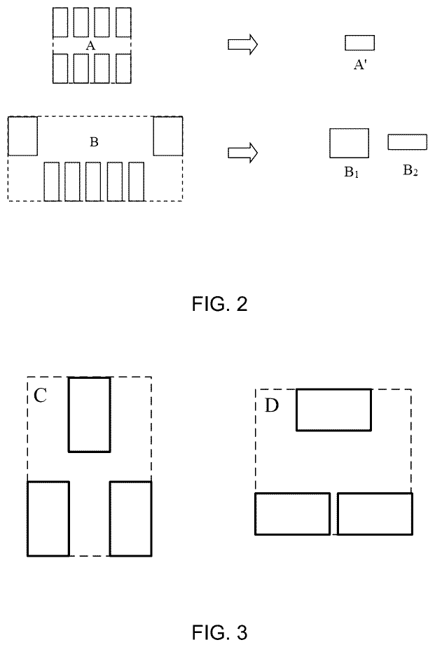

For example, referring to FIG. 2, if the component package pattern of Component package A recorded in the stencil opening library contains only one type of Pad pattern A′, and it is determined that the PCB contains Pad pattern A′ with the same pad pattern code, then Component package A is identified as a candidate component package. Similarly, if the component package pattern of Component package B recorded in the stencil opening library contains two types of pad patterns, B1 and B2, and it is determined by comparing the pad pattern codes that the PCB contains both pad patterns B1 and B2, then Component package B is identified as a candidate component package. It is understood that if any one of pieces of pad pattern data of a component package cannot be matched with pad pattern data from the PCB with the same pad pattern code, then that this component package cannot be considered a candidate component package.
S40: matching the pad pattern data of searched candidate component packages with the pad pattern data of the PCB based on the pad pattern codes.

Specifically, the pad pattern data of the component packages comprises pad positions and pad angles. For the pad pattern data of each candidate component package, a group of matched pad pattern data is identified from the pad pattern data of the PCB based on the pad position, pad angle, and pad pattern code of each of the pieces of pad pattern data.

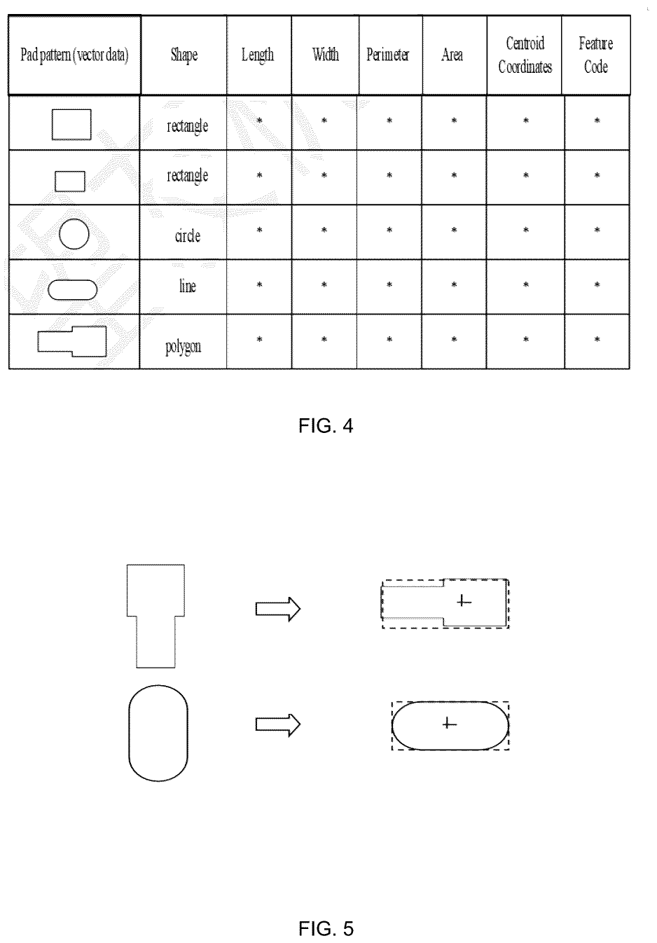

The pad angle refers to the angle between the length direction of the pad and the length direction of the component package. For example, as shown in FIG. 3, the rectangular pad pattern in Component package C has a pad angle of 90°, while the rectangular pad pattern in Component package D has a pad angle of 0°. The pad position refers to the coordinates of the pad within its corresponding component package pattern.
S50: generating a stencil opening layer of the PCB based on the stencil opening data of the successfully matched candidate component packages, to process the stencil template according to the stencil opening layer.

It is understood that, when a match is successful, the stencil opening data corresponding to the candidate component packages can be directly inherited from the stencil opening library as the stencil opening data corresponding to the matched group of pad pattern data for the candidate component packages, to generate the stencil opening layer of the PCB.

In the method for generating stencil openings provided by the present disclosure, a stencil opening library is pre-constructed. Based on this stencil opening library, after obtaining the Gerber file of the PCB, the pad pattern data of the PCB is subjected to graphical feature encoding. The obtained pad pattern codes are then used to search for candidate component packages containing the same pad pattern codes from the stencil opening library. Subsequently, the pad pattern data of the searched candidate component packages are matched with the pad pattern data of the PCB based on the pad pattern codes. In this way, the stencil opening layer of the PCB can be generated using the stencil opening data corresponding to the successfully matched candidate component packages. This achieves automated recognition of component packages without the need for manual identification of component packages in the solder-paste printing layer, thereby improving processing efficiency.

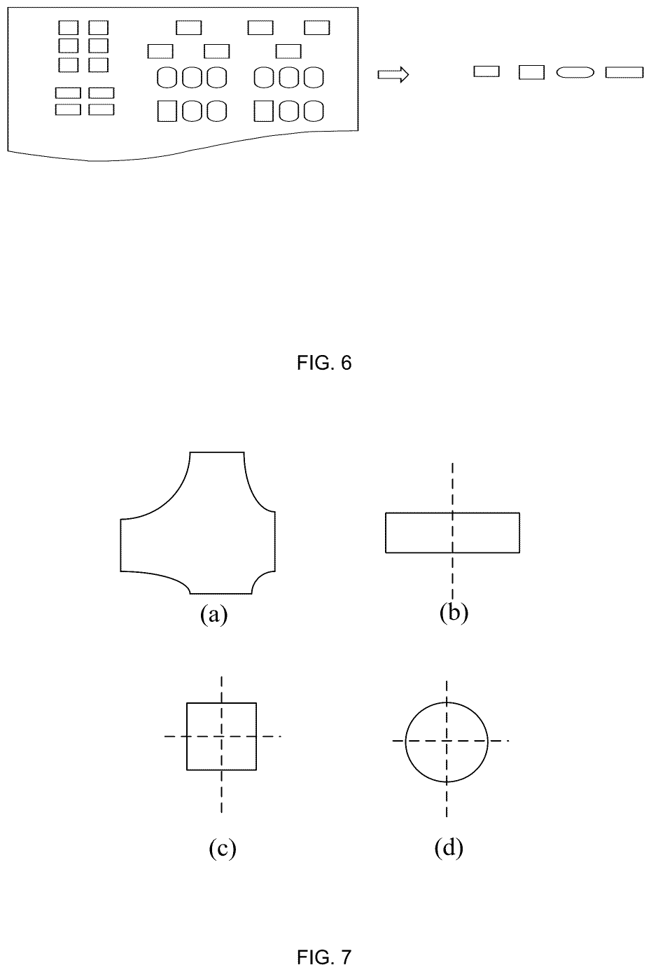

In one embodiment, before executing step S30, the method for generating stencil openings provided by the present disclosure may further comprise: summarizing the pieces of pad pattern data of the PCB based on the pad pattern codes to obtain summarized pad pattern data. FIG. 4 exemplifies the summarized pad pattern data, where it can be observed that the pad patterns are non-repeating.

Accordingly, step S30 comprises searching for the candidate component packages containing the same pad pattern codes from the preset stencil opening library based on the pad pattern codes of the summarized pad pattern data.

It is understood that the summarization operation can effectively reduce the quantity of PCB pad pattern data involved in step S30, thereby reducing the frequency of searching the stencil opening library for PCB pad pattern data during step S30 and improving the execution efficiency of step S30.

It should be noted that the summarized pad pattern data is used only to improve the execution efficiency of step S30, while subsequent steps S40 to S50 still use the non-summarized pad pattern data of the PCB.

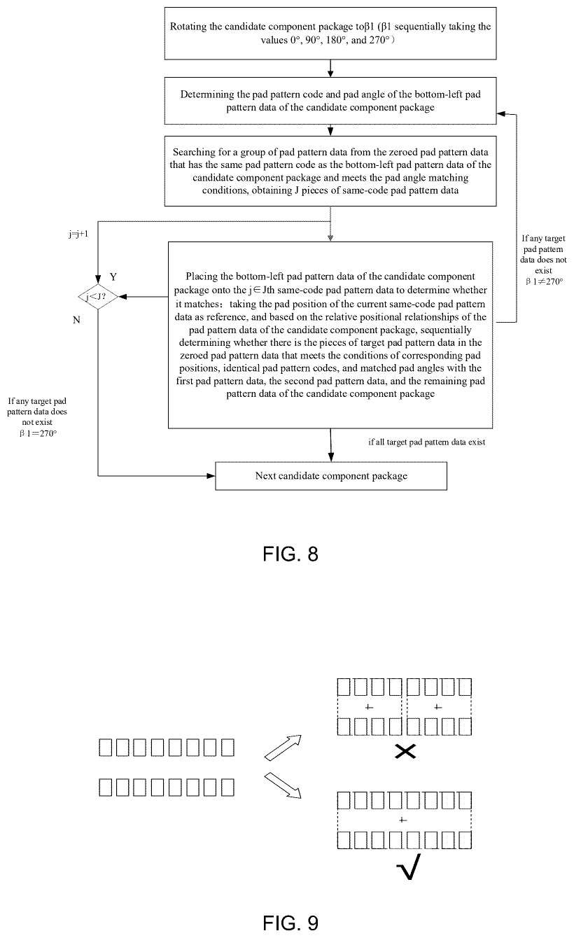

As mentioned above, the pad pattern data of component packages in the stencil opening library comprises pad positions and pad angles; on this basis, the method for generating stencil openings provided by the embodiments of the present disclosure may further comprise:
adjusting the pad angles of the pieces of pad pattern data of the PCB to a zero angle according to a preset zeroing method to obtain zeroed pad pattern data. Referring to the lower part of FIG. 5, when a centroid of the pad pattern corresponding to the pad pattern data coincides with a center, adjusting the pad angle to the zero angle by rotating a long side of the pad pattern to a horizontal direction. Referring to the upper part of FIG. 5, when the centroid of the pad pattern corresponding to the pad pattern data does not coincide with the center, adjusting the pad angle to the zero angle by rotating the long side of the pad pattern to the horizontal direction and placing the centroid of the pad pattern on a right side.

Accordingly, step S40 comprises:
S40′: for each candidate component package, utilizing the pad position, pad angle, and pad pattern code of the pad pattern data to search for a group of pad pattern data that matches the candidate component package from the zeroed pad pattern data.

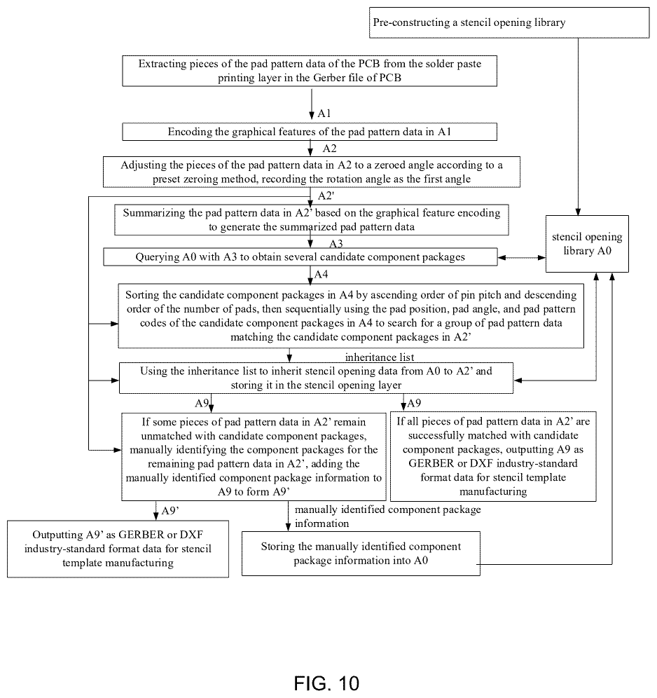

In a preferred implementation, the operation of adjusting all pad angles to a zero angle according to a preset zeroing method can be performed first. This can then be combined with the operation of summarizing the pad pattern data of the PCB based on their pad pattern codes. This approach further reduces the quantity of PCB pad pattern data involved in step S30, thereby enhancing the execution efficiency of step S30. As shown in FIG. 6, before summarization, the PCB contains a large amount of pad pattern data, whereas after summarization, only four types of pad pattern data remain.

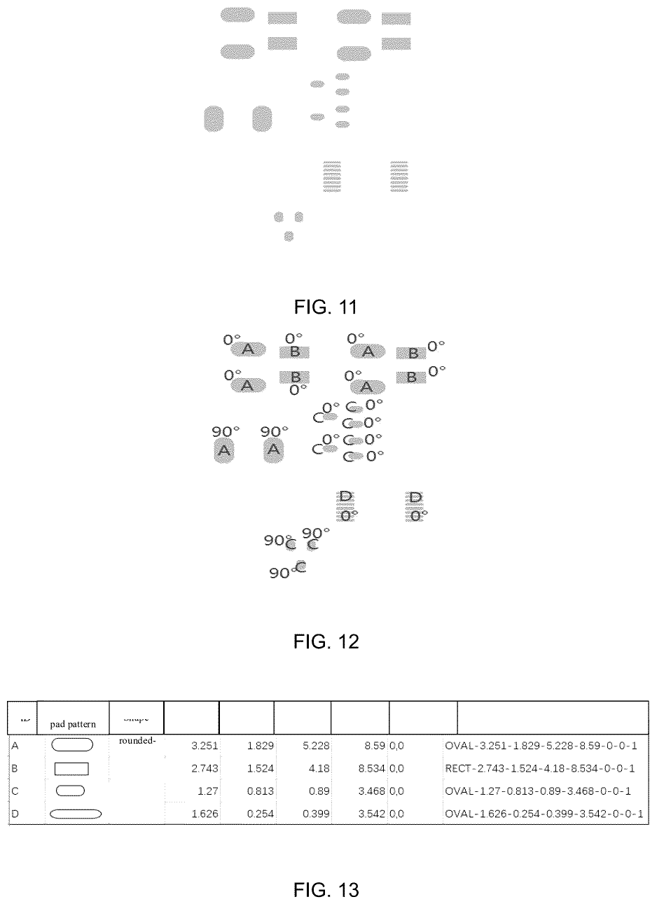

In addition, while adjusting the pad angles of the pieces of pad pattern data on the PCB to the zero angle according to the preset zeroing method, the rotation angle can be recorded as the first angle for the pad pattern data. Accordingly, step S40′ specifically comprises:
S40″: for each candidate component package, searching for a group of pad pattern data from the zeroed pad pattern data so that the pad positions of the group of pad pattern data correspond to the pad positions of the pad pattern data of the candidate component packages, and the corresponding pad pattern codes are the same and meet the preset angle matching conditions;
the angle matching conditions comprise:

$$\{ \begin{matrix}{β}_{3} & = β & Case 1 , \\ {β}_{3} & = β , or \vert {β}_{3} - β \vert = 180 ° & Case 2 , \\ {β}_{3} & = β , or \vert {β}_{3} - β \vert = 90 ° , or \vert {β}_{3} - β \vert = 180 ° , or \vert {β}_{3} - β \vert = 270 ° & Case 3 , and \\ {β}_{3} & = β or {β}_{3} \neq β & Case 4 ;\end{matrix}$$

where β₃=β₁−β₂+β; β₁ represents a second angle for rotating the candidate component package, and β₁ takes the values 0°, 90°, 180°, and 270° in sequence. That is, when searching for a group of matched pad pattern data for the candidate component package from the zeroed pad pattern data, the candidate component package is rotated in the sequence of β₁=0° 90°, 180°, 270°; β₂ represents the pad angle corresponding to the pad pattern data of the component package (refer to FIG. 3 for better understanding); β represents the first angle recorded when the pad angle of the PCB pad pattern data is adjusted to the zero angle.
Case 1: The pad pattern data corresponds to a non-rotationally symmetric pattern, as shown in portion (a) of FIG. 7;
Case 2: The pad pattern data corresponds to a rotationally symmetric pattern with a rotational angle of 0° or 180°, as shown in portion (b) of FIG. 7;
Case 3: The pad pattern data corresponds to a rotationally symmetric pattern with a rotational angle of 0°, 90° or a multiple of 90°, as shown in portion (c) of FIG. 7;
Case 4: The pad pattern data corresponds to a rotationally symmetric pattern with a rotational angle of any angle within 0° to 360°, as shown in portion (d) of FIG. 7.

It is understood that the component package information also comprises the number of pads in the component package; therefore, the specific execution process of the above step S40″ can be referred to as follows:
(1) for each candidate component package, searching for a group of pad pattern data from the zeroed pad pattern data that has the same pad pattern code as pieces of the bottom-left pad pattern data of the candidate component package and meets the pad angle matching conditions, obtaining multiple pieces of same-code pad pattern data;
(2) sequentially placing the pieces of the bottom-left pad pattern data of the candidate component package on multiple pieces of same-code pad pattern data to determine whether it matches, and searching for pad pattern data combinations that match the candidate component package according to a judgment result; the pad pattern data combinations correspond one-to-one with the pad pattern data of the component package; the pad pattern data in each pad pattern data combination corresponds one-to-one with the pad positions of the pad pattern data of the component package, and the corresponding pad pattern codes are the same and meet the pad angle matching conditions.

In step (2), for each judgment, the candidate component package is rotated by the second angle, and following search operations are performed:

taking the pad position of the current same-code pad pattern data as reference, and based on the relative positional relationships of pieces of pad pattern data of the candidate component package, sequentially determining whether there is pieces of target pad pattern data in the zeroed pad pattern data that meet the conditions of corresponding pad positions, identical pad pattern codes, and matched pad angles with first pad pattern data, second pad pattern data, and remaining pad pattern data of the candidate component package; the first pad pattern data is the pad pattern data furthest from the bottom-left pad pattern data, and the second pad pattern data is the pad pattern data closest to the bottom-left pad pattern data.

Additionally, during process of performing the search operation, if all pieces of target pad pattern data exist, grouping them together to obtain the pad pattern data combination, indicating a successful match, and the search for the next candidate component package is performed; otherwise, the candidate component package is rotated by next angle of the second angle, and the search operation is continued until the second angle has been taken sequentially as 0°, 90°, 180°, and 270°, then the search for the next candidate component package is performed.

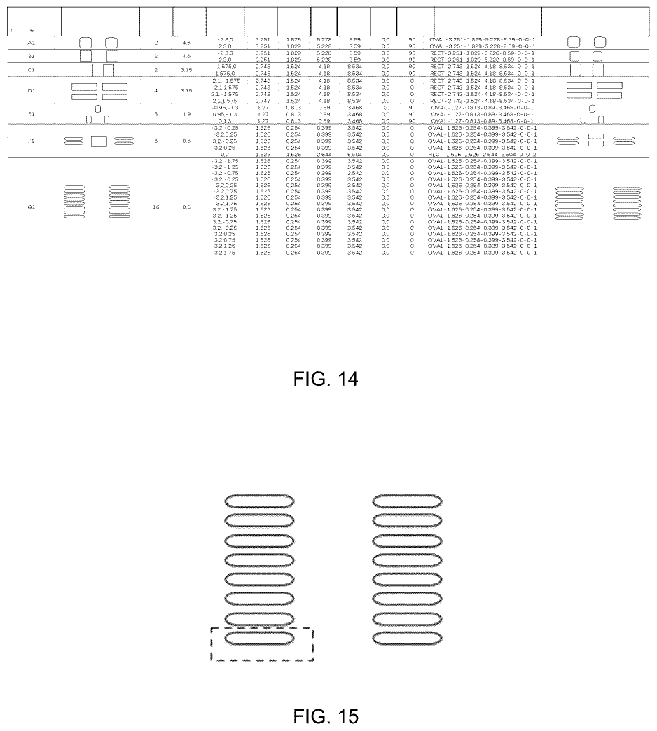

Specifically, referring to the main process shown in the middle of FIG. 8, during the execution of the above step S40″, the pad pattern code and pad angle of the bottom-left pad pattern data of the candidate component package are first determined; then, searching for a group of pad pattern data from the zeroed pad pattern data that has the same pad pattern code as the bottom-left pad pattern data of the candidate component package and meets the pad angle matching conditions, and supposing J pieces of same-code pad pattern data are found; sequentially placing the bottom-left pad pattern data of the candidate component package on the pieces of same-code pad pattern data to determine whether it matches, and searching for the pad pattern data combination that matches the candidate component package according to the judgment result; for each judgment, the candidate component package is first rotated by the second angle, then taking the pad position of the current same-code pad pattern data as reference, and based on the relative positional relationships of the pad pattern data of the candidate component package, sequentially determining whether there is the pieces of target pad pattern data in the zeroed pad pattern data that meets the conditions of corresponding pad positions, identical pad pattern codes, and matched pad angles with the first pad pattern data, the second pad pattern data, and the remaining pad pattern data of the candidate component package; if all pieces of the target pad pattern data exist, group them together to obtain a pad pattern data combination. That is, in this pad pattern data combination, there is indeed target pad pattern data that meets the conditions of corresponding pad positions, identical pad pattern codes, and matched pad angles with the first pad pattern data; there is target pad pattern data that meets the conditions of corresponding pad positions, identical pad pattern codes, and matched pad angles with the second pad pattern data; and there is target pad pattern data that meets the conditions of corresponding pad positions, identical pad pattern codes, and matched pad angles with the remaining pad pattern data of the candidate component package, respectively. Once this combination is established, the matching process can proceed to the next candidate component package.

When placing the bottom-left pad pattern data of the candidate component package on the j-th piece of same-code pad pattern data, if any one of pieces of the target pad pattern data does not exist, different branch processes will be selected based on whether the second angle has exhausted all four possible angles.

Specifically, referring to the branch process shown on the left side of FIG. 8, whenever the situation arises where one of pieces of the target pad pattern data cannot be found, and the second angle has already been sequentially set to 0°, 90°, 180°, and 270°, meaning the current second angle is 270°, then it is determined whether j<J holds true. This checks whether the currently placed same-code pad pattern data is the last one. If j<J holds true, the bottom-left pad pattern data of the candidate component package is placed onto the (j+1)-th piece of same-code pad pattern data for further matching. If j<J does not hold true, the process proceeds to the next candidate component package for further handling.

Referring to the branching process shown on the right side of FIG. 8, whenever the situation arises where one of pieces of the target pad pattern data cannot be found, and the second angle has not yet been sequentially set to 0°, 90°, 180°, and 270°, that is, the second angle has not yet reached 270°, the candidate component package is rotated to the next angle of the second angle, and the search continues. This process is repeated until the second angle has been sequentially set to 0°, 90°, 180°, and 270°, after which the search proceeds to the next candidate component package.

In practical applications, when determining whether the bottom-left pad pattern data of the candidate component package correspondingly matches the same-code pad pattern data, a temporary list can be constructed to store temporary component packages and their corresponding β₃ values, where β₃=β₁−β₂+β. Here, a temporary component package is obtained by rotating the candidate component package by a certain angle. Specifically, during each determination, β₃=β₁−β₂+β is calculated for the bottom-left pad pattern data of the candidate component package. The system then checks whether the temporary list already contains a temporary component package corresponding to β₃. If such a package exists, its bottom-left pad pattern data's pad angle and pattern data match the same-code pad pattern data's codes and satisfy the angle-matching conditions. Consequently, the pad position of this same-code pad pattern data is used as a reference, and the relationships between the pieces of pad pattern data within the temporary component package are used to confirm the existence of the target pad pattern data in the zeroed pad pattern data; if no corresponding β₃ is found, the candidate component package is rotated by β₁−β₂ to bring its bottom-left pad pattern data to the zeroed state; subsequently, the candidate component package is further rotated by β. After these two rotations, a new temporary component package is formed, which is stored in the temporary list alongside the corresponding β₃. This new temporary component package is then used to confirm the existence of the target pad pattern data as described earlier. After the bottom-left pad pattern data of the candidate component package is evaluated against the J-th piece of same-code pad pattern data, the temporary list is cleared. By constructing and utilizing a temporary list, the processing speed of matching candidate component packages with pad pattern data combinations is accelerated, thereby improving execution efficiency.

In one embodiment, based on step S40′, step S50 specifically comprises:
(1) recording the name of each successfully matched candidate component package, third angle β₄=β₁+β, and specified pad position of the pad pattern data successfully matched with the candidate component package, and summarizing each record to obtain an inheritance list;
(2) inheriting stencil opening data from the stencil opening library based on the inheritance list, and generating the PCB stencil opening layer based on the inherited stencil opening data; for each record, the corresponding stencil opening data is obtained from the stencil opening library based on the component package name in the record, and the stencil opening data is used based on the third angle and specified pad position in the record.

It is understood that, in step (2), after obtaining the corresponding stencil opening data from the stencil opening library based on the component package name, the pad angle of the retrieved stencil opening data is rotated according to the third angle. The rotated stencil opening data can then be used as the stencil opening data corresponding to the group of pad pattern data successfully matched with the candidate component package. During use, the stencil opening data's corresponding component package pattern and the group of pad pattern data have consistent pad positions to ensure that the stencil openings correspond one-to-one with the pads in the group of pad pattern data.

The specified pad position can be the bottom-left pad position of the group of pad pattern data successfully matched with the candidate component package.

In one embodiment, the method for generating stencil openings provided by the embodiments of the present disclosure may further comprise the following steps:
when any group of pad pattern data in the zeroed pad pattern data is successfully matched with the candidate component package, shielding the group of pad pattern data to continue matching the pad pattern data of the found candidate component package with remaining pad pattern data based on the pad pattern code.

Specifically, when any group of pad pattern data among the zeroed pad pattern data is successfully matched with a candidate component package, this group of pad pattern data can be marked. In subsequent matching processes, when pad pattern data of other candidate component packages is matched against the zeroed pad pattern data, the previously marked pad pattern data will no longer participate in the matching process.

In one embodiment, the component package information stored in the stencil opening library further comprises the pin pitch of the component package and the number of pads in the component package; accordingly, the method for generating stencil openings provided by the embodiments of the present disclosure may further comprise the following steps:
sorting the identified candidate component packages in ascending order of pin pitch and descending order of the number of pads, and executing step S40 according to the sorting result.

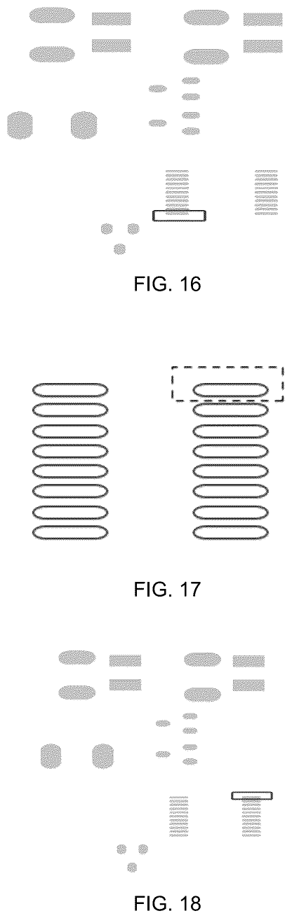

This sorting operation mainly aims to prevent a single component with a large number of pads on the PCB from being misidentified as multiple components with fewer pads. For example, referring to FIG. 9, the left side shows the pads of a component on the PCB, which adopts the SOP16 package. If this sorting operation is not performed, the group of pad pattern data contained in this component may be mistakenly matched with two candidate component packages of SOP8 in the upper right part of the figure, resulting in incorrect matching. However, if the above sorting operation is performed, the group of pad pattern data contained in the component will first be matched with the SOP16 package in the lower right part of the figure, effectively avoiding incorrect matching.

In one embodiment, the method for generating stencil openings provided by the embodiments of the present disclosure may further comprise the following steps:
when there is remaining pad pattern data on the PCB that has not been matched to the candidate component package, manually identifying the component package for the remaining pad pattern data; accordingly, step S50 may specifically comprise:
generating the PCB stencil opening layer based on the stencil opening data corresponding to the successfully matched candidate component packages and the stencil opening data corresponding to the manually identified component packages.

Additionally, the method for generating stencil openings further comprises: storing the information of the manually identified component packages for the remaining pad pattern data into the stencil opening library. As a result, with the increasing number of component packages stored in the stencil opening library, instances of unsuccessful matching will become progressively less frequent. Ultimately, fully automated recognition will be achieved, eliminating the need for manual identification and design, thereby realizing fully automated stencil design.

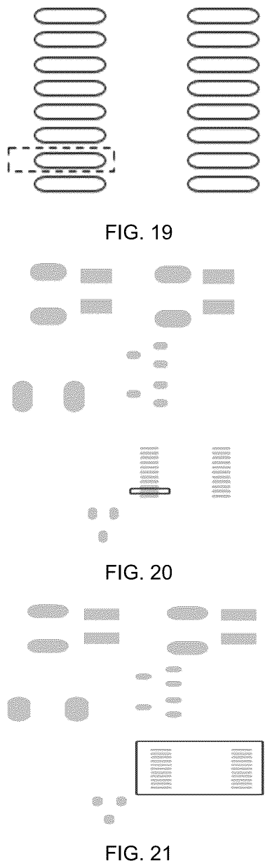

In a specific embodiment, referring to FIG. 10, the method for generating stencil openings provided by the embodiments of the present disclosure may comprise the following steps:
(1) pre-constructing a stencil opening library, denoted as A0;
(2) extracting pieces of the pad pattern data of the PCB from the solder-paste printing layer in the Gerber file of PCB, and denoting the extraction result as A1;
(3) encoding the graphical features of the pad pattern data in A1 to obtain the pad pattern codes, denoted as A2;
(4) adjusting the pieces of the pad pattern data in A2 to a zeroed angle according to a preset zeroing method, recording the rotation angle (i.e., the adjusted angle) as the first angle, and denoting the processed result as A2′;
(5) summarizing the pad pattern data in A2′ based on the graphical feature encoding to generate the summarized pad pattern data, denoted as A3;
(6) querying A0 with A3 to obtain several candidate component packages, denoted as A4;
(7) sorting the candidate component packages in A4 by ascending order of pin pitch and descending order of the number of pads, then sequentially using the pad position, pad angle, and pad pattern codes of the candidate component packages in A4 to search for a group of pad pattern data matching the candidate component packages in A2′; referring to FIG. 8 and the description of FIG. 8 in the above text for the search process, for each successfully matched group of pad pattern data, recording the candidate component package name, third angle, and the specified pad position of the matched group of pad pattern data of the PCB, shielding the matched group of pad pattern data; then, summarizing all records into an inheritance list;
(8) using the inheritance list to inherit stencil opening data from A0 to A2′ and storing it in the stencil opening layer, denoted as A9;
(9) if all pieces of pad pattern data in A2′ are successfully matched with candidate component packages, outputting A9 (i.e., the stencil opening data) as GERBER or DXF industry-standard format data for stencil template manufacturing;
(10) if some pieces of pad pattern data in A2′ remain unmatched with candidate component packages, manually identifying the component packages for the remaining pad pattern data in A2′, and adding the manually identified component package information to A9 to form A9′;
(11) storing the manually identified component package information into A0;
(12) outputting A9′ as GERBER or DXF industry-standard format data for stencil template manufacturing.

Next, the method for generating stencil openings provided by the embodiment of the present disclosure will be further explained in detail through a specific example.

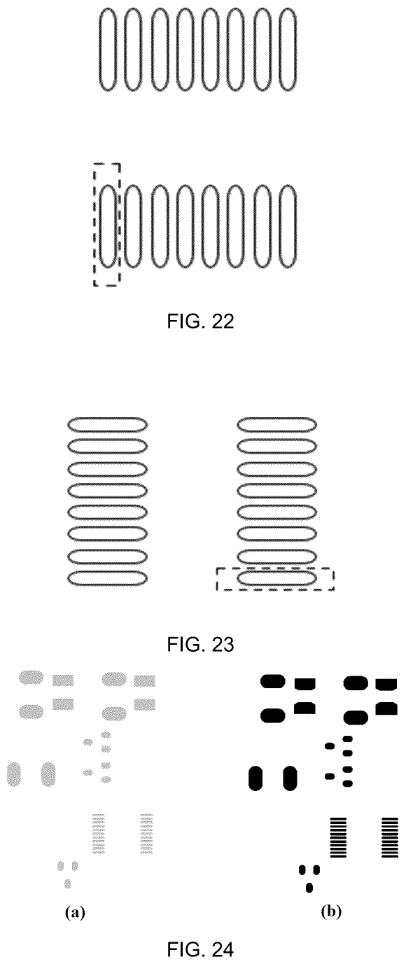

First, a Gerber file of a PCB is obtained and pieces of pad pattern data of the PCB are extracted from a solder-paste printing layer of the Gerber file, as shown in FIG. 11; the pad pattern data are encoded to obtain pad pattern codes, and the pad angles of the pad pattern data are adjusted to the zeroed state;
Then, the above-mentioned pad pattern data is summarized to obtain the summarized pad pattern data, shown in FIG. 12 and FIG. 13. The pad pattern data of Label A has a pad pattern code of OVAL-3.251-1.829-5.228-8.59-0-0-1, with pad angles of 0° and 90°; the pad pattern data of Label B has a pad pattern code of RECT-2.743-1.524-4.18-8.534-0-0-1, with a pad angle of 0°; the pad pattern data of Label C has a pad pattern code of OVAL-1.27-0.813-0.89-3.468-0-0-1, with pad angles of 0° and 90°; the pad pattern data of Label D has a pad pattern code of OVAL-1.626-0.254-0.399-3.542-0-0-1, with a pad angle of 0°.

It is assumed that the stencil opening library already contains the component package information shown in FIG. 14. Based on the pad pattern codes of the summarized pad pattern data shown in FIG. 13, the stencil opening library is searched for candidate component packages with the same pad pattern code. The identified candidate component packages comprise A1, C1, D1, E1, F1, G1.

The identified candidate component packages are sorted in ascending order of pin pitch and descending order of the number of pads. The resulting order for processing is G1, F1, D1, E1, C1, A1. Starting with G1, the pad pattern of G1 has only one type. In the PCB, there are sixteen instances of pad pattern data with the same code as this pad pattern, meaning the PCB contains sixteen pieces of same-code pad pattern data, i.e., J=16. Therefore, there are sixteen pieces of same-code pad pattern data in the PCB to be determined for matching with G1. At this point, the sixteen pieces of same-code pad pattern data can be sorted based on the coordinates of the bottom-left pad, following the order from left to right and from bottom to top. However, this sorting operation is not mandatory.

Specifically, the process begins by placing the bottom-left pad pattern data of the candidate component package G1 onto the first one of the pieces of same-code pad pattern data to determine whether it matches: rotating G1 by β₁=0° and calculating β₃=β₁−β₂+β=0°−0°+0°=0°; searching for the temporary list, and when there is no temporary component package named G1 corresponding to β₃=0° is searched, rotating the candidate component package G1 by β₁-β₂=0°, then further rotating it by β=0°, resulting in a temporary component package G1 corresponding to β₃=0°; and recording this temporary component package G1 into the temporary list; and placing the bottom-left pad pattern data of the temporary component package G1 onto the first one of the pieces of same-code pad pattern data, as shown in FIG. 16.

### Temporary List

| Temporary | |
|---|---|
| Component Package | β₃ |
| G1 | 0 |
| . . . | . . . |

After placing the bottom-left pad pattern data of G1, based on the coordinate position of the bottom-left pad pattern data (−3.2,−1.75), the first pad pattern data that is farthest from the coordinates (−3.2,−1.75) is identified within the G1 component package. As shown in FIG. 17, the pad pattern code of the first pad pattern data is OVAL-1.626-0.254-0.399-3.542-0-0-1, with a pad angle of 0°. The coordinate position of this first pad pattern data is (3.2, 1.75). Relative to the coordinates (−3.2,−1.75) of the bottom-left pad pattern data, the relative coordinates of the first pad pattern data can be calculated as (3.2−(−3.2), 1.75−(−1.75))=(6.4, 3.5) by using the coordinates (−3.2,−1.75) of the bottom-left pad pattern data as a reference. Based on the relative coordinates, a target pad pattern data is searched for at the coordinates (6.4, 3.5) on the basis of the coordinate location of the bottom-left pad pattern data. If no pad pattern data is found at this coordinate location, or if the pad pattern code is different, or if the pad angle does not satisfy the angle matching conditions, it is determined that no target pad pattern data has been found. In such a case, the process proceeds to place the bottom-left pad pattern data of the candidate component package G1 onto the next one of the pieces of same-code pad pattern data for further matching evaluation. If a pad pattern data with the same pad pattern code is found and the angle matching conditions are satisfied, the target pad pattern data is considered to have been found, as shown in FIG. 18, and the next step is continued.

The second pad pattern data that is closest to the coordinates (−3.2,−1.75) of the bottom-left pad pattern data is identified within the G1 component package. As shown within the dashed box in FIG. 19, the pad pattern code denoted as OVAL-1.626-0.254-0.399-3.542-0-0-1 and the pad angle denoted as 0° of the second pad pattern data are recorded. The coordinate position of the second pad pattern data is (−3.2,−1.25); relative to the coordinates (−3.2,−1.75) of the bottom-left pad pattern data, the relative coordinates of the second pad pattern data can be calculated as ((−3.2)−(−3.2), (−1.25)−(−1.75))=(0, 0.5) by using the coordinates (−3.2,−1.75) of the bottom-left pad pattern data as a reference. Based on the relative coordinates, a target pad pattern data is searched for at the coordinates (0, 0.5) on the basis of the coordinate location of the bottom-left pad pattern data. If no pad pattern data is found at this coordinate location, or if the pad pattern code is different, or if the pad angle does not satisfy the angle matching conditions, it is determined that no target pad pattern data has been found. The process continues by placing the bottom-left pad pattern data of the candidate component package G1 onto the next one of the pieces of same-code pad pattern data to determine whether it matches. If a pad pattern data with the same pad pattern code is found and satisfies the angle matching conditions, it indicates that the target pad pattern data has been successfully identified, as shown in FIG. 20, and the next step is then carried out.

The remaining pieces of pad pattern data in the candidate component package G1 are sequentially processed by utilizing their pad pattern codes, pad angles, and pad positions. The bottom-left pad pattern data of G1 is placed on the first one of pieces of same-code pad pattern data to search for corresponding pad pattern data at the specified positions. This process is repeated until all pieces of pad pattern data in G1 are found at their corresponding positions in the zeroed pad pattern data, indicating that the identified pad pattern data matches the G1 component package. These pieces of identified pad pattern data are grouped as one group of pad pattern data. The third angle of the component package G1 is recorded as β₄=β₁+β=0°+0°=0°, along with the coordinates (−3.2,−1.75) of the bottom-left pad pattern data of G1, which is added to the inheritance list. A shielding marker is added to this matched group of pad pattern data, ensuring that they are excluded from subsequent matching processes for other candidate component packages. Ultimately, pieces of the matched PASTE pad pattern data are successfully identified, as shown in FIG. 21.

### Inheritance List

| | | Coordinates of Bottom- |
|---|---|---|
| Component | | Left Pad Pattern Data of |
| Package | β₄ | Component Package |
| G1 | 0° | (−3.2, −1.75) |
| . . . | . . . | . . . |

Additionally, when placing the bottom-left pad pattern data of the candidate component package G1 onto the first one of pieces of same-code pad pattern data for matching evaluation and no target pad pattern data is found, the candidate component package G1 is rotated to β₁=90°. After rotating to β₁=90°, the patterns corresponding to the pad pattern data of G1 have a short horizontal and long vertical arrangement, as shown in FIG. 22; next, β₃ is calculated as β₁−β₂+β=90°−0°+0°=90°. Since no temporary component package named G1 corresponding to β₃=90° is found in Temporary List 1, the candidate component package G1 is first rotated by β₁−β₂=90° to zero out the bottom-left pattern. After rotation, as shown in FIG. 23, G1 is further rotated by β=0°, resulting in a temporary component package named G1. This temporary component package is stored in the temporary list, and the bottom-left pad pattern data is placed onto the first one of pieces of same-code pad pattern data. After this, the process proceeds to search for the target pad pattern data following the steps used for β₁=0°. Similarly, if all pieces of pad pattern data of the G1 component package are located in the corresponding positions of the zeroed pad pattern data, they are grouped as one group of pad pattern data. The relevant information is recorded into the inheritance list, and a shielding marker is added to this group of matched pad pattern data. If any one of pieces of pad pattern data of the G1 component package fail to be located in the corresponding positions, G1 is rotated to the next β₁ value, repeating the process until β₁ has sequentially taken the values 0°, 90°, 180°, and 270°.

### Temporary List

| Temporary | |
|---|---|
| Component Package | β₃ |
| G1 | 0° |
| G1 | 90° |
| . . . | . . . |

After β₁ sequentially takes the values 0°, 90°, 180°, and 270°, the bottom-left pad pattern data of the candidate component package G1 is placed onto the first one of pieces of same-code pad pattern data. If the target pad pattern data for all pieces of pad pattern data in G1 cannot be found in the zeroed pad pattern data, it is deemed a matching failure. Following the process described above, the bottom-left pad pattern data of the candidate component package G1 is then placed onto the next one of pieces of same-code pad pattern data for further matching evaluation. This continues until a matched group of pad pattern data is found, at which time, the matching process for the candidate component package G1 is completed, or until the bottom-left pad pattern data of G1 is placed onto the 16th piece of same-code pad pattern data for evaluation and no match is found. If the matching fails at this point, the matching process for the candidate component package G1 is concluded.

After completing the matching process for the candidate component package G1, the temporary list is cleared. The matching process then proceeds to the next component package F1, repeating until all component packages have been processed. The specific steps follow the process outlined for G1.

The successfully matched component packages are G1, E1, C1, and A1. Their corresponding stencil opening patterns are located in the stencil opening library and placed onto the stencil opening layer based on the inheritance list. The final result is shown in FIG. 24; where the left portion (a) represents the solder-paste printing layer, and the right portion (b) shows the stencil opening layer generated after matching. Additionally, the final matched component packages of the PCB are displayed in FIG. 25 and detailed in the following list.

| | | Coordinates of Bottom- |
|---|---|---|
| Component | | Left Pad pattern data of |
| Package | β₄ | Component Package |
| A1 | 270° | (−2.3, 0) |
| C1 | 270° | (−1.575, 0) |
| A1 | 270° | (−2.3, 0) |
| C1 | 270° | (−1.575, 0) |
| E1 | 270° | (−0.95, −1.3) |
| A1 | 0° | (−2.3, 0) |
| E1 | 270° | (−0.95, −1.3) |
| G1 | 0° | (−3.2, −1.75) |
| E1 | 180° | (−0.95, −1.3) |

Then, the stencil opening layer is output as a GERBER or DXF industry-standard format data file for stencil template manufacturing.

Additionally, if there are any one of pieces of pad pattern data on the PCB that has not been matched to candidate component packages, the remaining pad pattern data can be manually identified to determine the corresponding component packages. The stencil opening design can then be completed by referencing both the automatically matched component packages and the manually identified component packages. Moreover, the information of the manually identified component packages is simultaneously stored into the stencil opening library. As the number of component packages in the stencil opening library grows, instances of unmatched cases will gradually decrease, enabling fully automated recognition and achieving complete automation of stencil design without requiring manual involvement in the process.

Corresponding to the above-mentioned method for generating stencil openings, the embodiments of the present disclosure also provide a device for generating stencil openings. This device is applied to electronic equipment and comprises an acquisition module, an encoding module, a search module, a matching-processing module, and a generation module.

The acquisition module obtains the Gerber file of the PCB and extracts pieces of the pad pattern data from the solder-paste printing layer of the Gerber file.

The encoding module encodes the graphical features of the pad pattern data to obtain the pad pattern codes.

The search module searches for candidate component packages containing the same pad pattern code in the preset stencil opening library based on the pad pattern codes of the pad pattern data of the PCB. The stencil opening library stores component package information based on the component packages. The component package information comprises: component package name, component package pattern, pad pattern data of the component package, and the stencil opening data corresponding to the component packages. Each of pieces of pad pattern data of the component package corresponds to a pad pattern code.

The matching-processing module matches the pad pattern data of the searched candidate component packages with the pad pattern data of the PCB based on the pad pattern codes.

The generation module generates the PCB stencil opening layer based on the stencil opening data of the successfully matched candidate component packages, to process the stencil template according to the stencil opening layer.

The modules of the device for generating stencil openings provided by the present disclosure can specifically execute part or all of the steps of the previously described method for generating stencil openings. The implementation principles and technical effects are similar to those described in the preceding method embodiments.

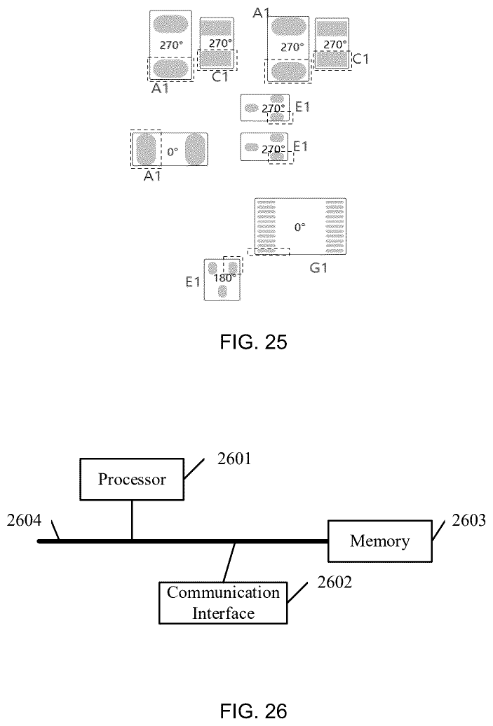

As shown in FIG. 26, the present disclosure also provides an electronic equipment comprising a processor 2601, a communication interface 2602, a memory 2603, and a communication bus 2604. The processor 2601, the communication interface 2602, and the memory 2603 communicate with one another via the communication bus 2604.

The memory 2603 is used for storing computer programs.

The processor 2601 is configured to implement the method for generating stencil openings of any of the aforementioned method embodiments when executing the computer programs stored in the memory 2603.

The communication bus mentioned in the electronic equipment can be a Peripheral Component Interconnect (PCI) bus or an Extended Industry Standard Architecture (EISA) bus, among others. The communication bus can be divided into an address bus, a data bus, and a control bus. For convenience of representation, only a thick line is used in FIG. 26, but it does not mean that there is only one bus or one type of bus.

The communication interface is used for communication between the electronic equipment and other devices.

The memory can comprise Random Access Memory (RAM) or Non-Volatile Memory (NVM), such as at least one disk-based storage. Optionally, the memory may also comprise at least one storage device located remotely from the processor.

The processor can be a general-purpose processor, such as a Central Processing Unit (CPU) or a Network Processor (NP); it may also be a Digital Signal Processor (DSP), an Application Specific Integrated Circuit (ASIC), a Field-Programmable Gate Array (FPGA), or other programmable logic devices, discrete gates or transistor logic devices, or discrete hardware components.

The present disclosure also provides a non-transitory computer-readable storage medium. The storage medium contains a computer program, and the computer program is executed by a processor to implement the method for generating stencil openings of any of the aforementioned method embodiments.

Optionally, the computer-readable storage medium can be a Non-Volatile Memory (NVM), such as one or more disk-based storage.

Optionally, the computer-readable storage medium may comprise at least one storage device located remotely from the aforementioned processor.

In another embodiment of the present disclosure, a computer program product containing instructions is provided. When the product runs on a computer, it enables the computer to execute the method for generating stencil openings of any of the aforementioned method embodiments.

It should be noted that for the embodiments involving the device/electronic equipment/storage medium/computer program product, the descriptions are relatively simplified due to their similarities to the method embodiments. Relevant parts can refer to the descriptions provided in the method embodiments.

It is understood by those skilled in the art that the embodiments of the present disclosure can be provided as a method, device, or computer program product. Thus, the present disclosure can take the form of a purely hardware implementation, a purely software implementation, or a combination of both hardware and software. These are collectively referred to as “modules.” Furthermore, the presently disclosed embodiments can be implemented as a computer program product stored on one or more computer-readable storage medium containing computer-usable program code. The storage medium may include, but are not limited to, disk storage, CD-ROMs, optical storage, and so forth. The computer program can be stored or distributed on an appropriate medium, provided alongside other hardware, or as a part of hardware; it can also be distributed in other forms, such as via the Internet or other wired or wireless telecommunications systems.

In addition, the terms like “first” and “second” are used for descriptive purpose only, and are not to be construed as indicating or implying relative importance or implicitly specifying numbers of technical features indicated. In the present disclosure, “group” and/or “set” means two or more, unless otherwise expressly specified. In the present disclosure, terms like “an embodiment,” “one embodiment,” “an example,” “specific example”, or “some examples” mean that the specific features, structures, materials, or characteristics represented in conjunction with the embodiment or example are included in at least one embodiment or example of the present disclosure. In the present disclosure, when the same expression from the above list is used for several times, it doesn't mean that they refer to the same embodiment or example. Further, the specific features, structures, materials, or characteristics represented in any embodiments or examples may be combined in a suitable manner.

The above content provides a detailed explanation of the present disclosure in conjunction with specific preferred embodiments. However, it should not be assumed that the specific embodiments of the present disclosure are limited to these descriptions. For those skilled in the technical field to which the present disclosure belongs, several simple deductions or substitutions can be made without departing from the inventive concept. All such modifications should be considered within the scope of protection of the present disclosure.

1. A method for generating stencil openings, wherein the method is applied to an electronic equipment and comprises:
obtaining a Gerber file of a PCB and extracting pieces of pad pattern data of the PCB from a solder-paste printing layer of the Gerber file;
encoding graphical features of the pad pattern data to obtain pad pattern codes;
searching for candidate component packages containing the same pad pattern codes in a preset stencil opening library based on the pad pattern codes of the pad pattern data of the PCB; wherein the stencil opening library stores component package information by the component packages;
wherein the component package information comprises: component package name, component package pattern, pad pattern data of the component packages, and stencil opening data corresponding to the component packages; wherein each of the pieces of pad pattern data of the component packages corresponds to one pad pattern code;
matching the pad pattern data of the component packages with the pad pattern data of the PCB based on the pad pattern codes; and
generating a stencil opening layer of the PCB based on the stencil opening data of the component packages successfully matched with the pad pattern data of the PCB, to process a stencil template according to the stencil opening layer.

2. The method for generating stencil openings according to claim 1, wherein before searching for the candidate component packages, the method further comprises:
summarizing pad patterns corresponding to the pad pattern data of the PCB based on the pad pattern codes to obtain pieces of summarized pad pattern data;
wherein searching for the candidate component packages comprises:
searching for the candidate component packages containing the same pad pattern codes from the preset stencil opening library based on pad pattern codes of the summarized pad pattern data.

3. The method for generating stencil openings according to claim 1, wherein the pieces of pad pattern data of the component packages comprise pad positions and pad angles, and the method further comprises:
adjusting the pad angles of the pieces of pad pattern data of the PCB to a zero angle according to a preset zeroing method to obtain pieces of zeroed pad pattern data; wherein when a centroid of one of the pad patterns corresponding to the pad pattern data coincides with a center, adjusting the pad angle to the zero angle by rotating a long side of the pad pattern to a horizontal direction; wherein when the centroid of the pad pattern does not coincide with the center, adjusting the pad angle to the zero angle by rotating the long side of the pad pattern to the horizontal direction and placing the centroid of the pad pattern on a right side;
wherein matching the pad pattern data of the candidate component packages with the pad pattern data of the PCB comprises:
for each of the candidate component packages, utilizing the pad positions, pad angles, and pad pattern codes of the pad pattern data to search for a group of pad pattern data that matches the candidate component package from the zeroed pad pattern data.

4. The method for generating stencil openings according to claim 3, wherein the method further comprises: recording a rotation angle as a first angle of the pad pattern data while adjusting the pad angles of the pad pattern data of the PCB to the zero angle;
wherein searching for a group of pad pattern data that matches the candidate component package comprises:
for each of the candidate component packages, searching for a group of pad pattern data from the zeroed pad pattern data, so that the pad positions of the group of pad pattern data correspond to the pad positions of the pad pattern data of the candidate component package, the corresponding pad pattern codes are the same, and preset angle matching conditions are met;
wherein the angle matching conditions comprise:
$$\{ \begin{matrix}{β}_{3} & = β & Case 1 , \\ {β}_{3} & = β , or \vert {β}_{3} - β \vert = 180 ° & Case 2 , \\ {β}_{3} & = β , or \vert {β}_{3} - β \vert = 90 ° , or \vert {β}_{3} - β \vert = 180 ° , or \vert {β}_{3} - β \vert = 270 ° & Case 3 , and \\ {β}_{3} & = β or {β}_{3} \neq β & Case 4 ;\end{matrix}$$
where β₃=β₁−β₂+β, β₁ represents a second angle for rotating the candidate component packages, and B, takes the values 0°, 90°, 180°, and 270° in sequence; β₂ represents the pad angle of the pad pattern data of the component packages, and β represents the first angle; wherein
Case 1: the pad pattern data corresponds to a non-rotationally symmetric pattern;
Case 2: the pad pattern data corresponds to a rotationally symmetric pattern with a rotation angle of 0° or 180°;
Case 3: the pad pattern data corresponds to a rotationally symmetric pattern with a rotation angle of 0°, 90°, or a multiple of 90°;
Case 4: the pad pattern data corresponds to a rotationally symmetric pattern with a rotation angle of any angle within 0° to 360°.

5. The method for generating stencil openings according to claim 4, wherein the component package information further comprises: the number of pads of the component packages;
wherein, for each of the candidate component packages, searching for a group of pad pattern data from the zeroed pad pattern data comprises:
for each of the candidate component packages, searching for a group of pad pattern data from the zeroed pad pattern data that has the same pad pattern code as the bottom-left pad pattern data of the candidate component package and meets the pad angle matching conditions, to obtain pieces of same-code pad pattern data;
sequentially placing the bottom-left pad pattern data of the candidate component package on the pieces of same-code pad pattern data to determine whether it matches, and finding pad pattern data combinations that match the candidate component package according to a judgment result; wherein the pad pattern data combinations correspond one-to-one with the pad pattern data of the component package; wherein the pad pattern data in one of the pad pattern data combinations corresponds one-to-one with the pad positions of the pad pattern data of the component packages, the pad pattern codes are the same, and the pad angle matching conditions are met;
wherein for each judgment, the candidate component package is rotated by the second angle, and then following search operations are performed:
taking the pad position of the current same-code pad pattern data as a reference, and based on the relative positional relationships of the pieces of pad pattern data of the candidate component package, sequentially determining whether there are pieces of target pad pattern data in the zeroed pad pattern data that meet the conditions of corresponding pad positions, identical pad pattern codes, and matched pad angles with first pad pattern data, second pad pattern data, and remaining pad pattern data of the candidate component package; wherein the first pad pattern data is the pad pattern data furthest from the bottom-left pad pattern data, and the second pad pattern data is the pad pattern data closest to the bottom-left pad pattern data;
wherein during process of performing the search operations, if all pieces of target pad pattern data exist, grouping them together to obtain one pad pattern data combination, indicating a successful match, and searching for the next one of the candidate component packages; otherwise, rotating the candidate component package by next angle of the second angle, and continually performing the search operation until the second angle has been taken sequentially as 0°, 90°, 180°, and 270°, then searching for the another one of the candidate component packages.

6. The method for generating stencil openings according to claim 4, wherein the stencil opening layer of the PCB is generated by:
recording the component package name of each of the candidate component packages successfully matched with the pad pattern data of the PCB, third angle β₄=β₁+β, and specified pad position of the pad pattern data of the PCB corresponding to the candidate component package, and summarizing records to obtain an inheritance list; and
inheriting the stencil opening data from the stencil opening library based on the inheritance list to obtain inherited stencil opening data, and generating the stencil opening layer based on the inherited stencil opening data;
wherein for each of the records, the corresponding stencil opening data is obtained from the stencil opening library based on the component package name in the record, and the stencil opening data is used based on the third angle and the specified pad position in the record.

7. The method for generating stencil openings according to claim 3, wherein the method further comprises:
when one of groups of pad pattern data in the zeroed pad pattern data is successfully matched with the candidate component package, shielding the group of pad pattern data, and continually matching the pad pattern data of the candidate component packages with remaining groups of pad pattern data in the zeroed pad pattern data based on the pad pattern codes.

8. The method for generating stencil openings according to claim 1, wherein the component package information further comprises pin pitch and the number of pads of the component package; wherein the method further comprises:
sorting the candidate component packages by ascending order of pin pitch and descending order of the number of pads to obtain a sorting result, and matching, based on the sorting result, the pad pattern data of the candidate component packages with the pad pattern data of the PCB through the pad pattern codes.

9. The method for generating stencil openings according to claim 4, wherein the pad pattern codes comprise information of pad pattern corresponding to the pad pattern data, and the pad pattern information comprises: shape, length, width, area, perimeter, centroid coordinates, and symmetry mark;
wherein the symmetry mark is used to mark whether the pad pattern belongs to case 1, case 2, case 3, or case 4.

10. The method for generating stencil openings according to claim 1, wherein the method further comprises:
when there is one of pieces of pad pattern data on the PCB that has not been matched to a corresponding candidate component package, manually identifying the component packages for said pad pattern data;
wherein the stencil opening layer of the PCB is generated by:
generating the stencil opening layer based on the stencil opening data of the component packages successfully matched with the pad pattern data of the PCB and stencil opening data of the component packages subjected to manual identification;
wherein the method for generating stencil openings further comprises:
storing component package information of pad pattern data of the component packages subjected to manual identification into the stencil opening library.

11. A device for generating stencil openings, wherein the device is applied to an electronic equipment and comprises:
an acquisition module, used to obtain a Gerber file of a PCB and extract pieces of pad pattern data from a solder-paste printing layer of the Gerber file;
an encoding module, used to encode graphical features of the pad pattern data to obtain pad pattern codes;
a search module, used to search for candidate component packages containing the same pad pattern codes in a preset stencil opening library based on the pad pattern codes of the pad pattern data of the PCB; wherein the stencil opening library stores component package information by component packages; wherein the component package information comprises: component package name, component package pattern, pad pattern data of the component packages, and stencil opening data corresponding to the component packages; each of the pieces of pad pattern data of the component packages corresponds to one pad pattern code;
a matching-processing module, used to match the pad pattern data of the candidate component packages with the pad pattern data of the PCB based on the pad pattern codes; and
a generation module, used to generate a stencil opening layer of the PCB based on the stencil opening data of the candidate component packages successfully matched with the pad pattern data of the PCB, to process a stencil template according to the stencil opening layer.

12. An electronic equipment, comprising: a processor, a communication interface, a memory, and a communication bus; wherein the processor, the communication interface, and the memory communicate with each other via the communication bus;
wherein the memory is used to store computer programs;
wherein the processor implements the method for generating stencil openings according to claim 1 when executing the computer programs stored in the memory.

13. A non-transitory computer-readable storage medium, which stores a computer program, and the method for generating stencil openings according to claim 1 is implemented when the computer program is executed by a processor.
